(19) United States
(12) Patent Application Publication
(10) Pub. No.: US 2015/0112036 A1
(43) Pub. Date: Apr. 23, 2015

(54) PARTIALLY FLUORINATED POLYMERS

(71) Applicant: E I DU PONT DE NEMOURS AND COMPANY, Wilmington, DE (US)

(72) Inventors: Roman B. LARICHEV, Wilmington, DE (US); Michael Henry OBER, Newark, DE (US); John SINICROPI, Rochester, NY (US)

(73) Assignee: E I DU PONT DE NEMOURS AND COMPANY, Wilmington, DE (US)

(21) Appl. No.: 14/055,934

(22) Filed: Oct. 17, 2013

(51) Int. Cl. C08F 220/38; C08G 18/38; C08F 220/22

(52) U.S. Cl. CPC C08F 220/38; C08F 220/22; C08G 18/3802
USPC 526/243; 526/245; 528/59

(57) ABSTRACT

The present invention relates to a polymer comprising the reaction product of: (a) a compound of Formula (3), or a mixture thereof:

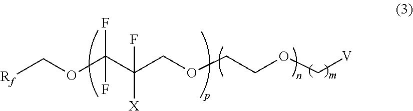

defined herein and (b) at least one ethylenically unsaturated monomer having a functional group. The present invention also relates to a polymer having at least one carbamate linkage prepared by: (i) reacting (a) at least one diisocyanate, polyisocyanate, or mixture thereof, having isocyanate groups, and (b) at least one fluorinated compound selected from the formula (2):

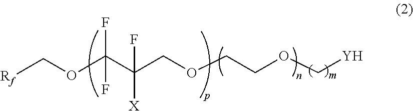

defined herein and (ii) optionally reacting with (c) water, a linking agent, or a mixture thereof. The polymers are useful as additives in coating compositions and film forming foams, which impart surface effects to substrates coated with such compositions and to film forming foams.

### FIELD OF THE INVENTION

The field of invention is related partially fluorinated polymers useful as additives in coating compositions and film forming foams, which impart surface effects to substrates coated with such compositions and to film forming foams.

### BACKGROUND OF THE INVENTION

Partially fluorinated alcohol and derivative compounds are commonly prepared from long chain fluorinated iodides or a mixture of long chain fluorinated iodides. These alcohols are expensive and in short supply. Shorter chain fluorinated alcohols would provide a reduction of fluorine in the resulting derivative compounds, which is desirable if the same or improved performance can be maintained in imparting surface effects to substrates and foams treated therewith. Reduction of fluorine in the fluorinated alcohols would also reduce the cost to produce these materials.

Honda et al., in Macromolecules, 2005, 38, 5699-5705 show that for perfluoroalkyl chains of 8 carbons or greater, orientation of the perfluoroalkyl groups is maintained in a parallel configuration, while reorientation occurs for such chains having 6 carbon atoms or less. Such reorientation decreases surface properties such as receding contact angle. Thus, shorter chain perfluoroalkyls have traditionally not been successful commercially for imparting surface effects to substrates and film forming foams.

Wiley (U.S. Pat. No. 2,988,537) discloses several carbonates, esters, oxalate esters, and amides used as trapping agents to form fluorinated products ranging from ketones with only one fluorinated group, to symmetrical ketones with two fluorinated groups, to fluorinated esters. In the majority of reactions, a mixture of products was obtained. However, the scope of this reaction was not fully developed to include the fluorine efficient intermediates, carboxylic acids, alcohols, and derivatives of the present invention.

It is desirable to have new, more selective chemistry, which provides a more fluorine efficient building block for use as an intermediate, to produce fluorinated polymers providing surface effects to substrates and foams treated therewith. The present invention solves this problem.

### SUMMARY OF INVENTION

The present invention relates to a polymer comprising the reaction product of: (a) a compound of Formula (3), or a mixture thereof:

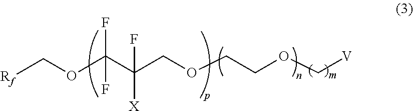

wherein R_{f} is C₁ to C₆ linear or branched fluoroalkyl; X is F or Cl; V is —YC(O)CR²═CH₂, —YC(O)R¹⁹SH, or —YC(O)NHCH₂CH₂OC(O)CR²═CH₂; Y is O or a single bond; R² is independently selected from H or a C₁ to C₄ alkyl group; R¹⁹ is an alkylene of about 1 to about 10 carbon atoms; p is 0 to 1; m is 0 or 3 to 10, and n is 0 to 30; wherein at least one of p or m is a positive integer; provided that, if n is a positive integer, then p is 1; and provided that, if m is 0 then Y is a single bond, and if m is a positive integer then Y is O; and (b) at least one ethylenically unsaturated monomer having a functional group selected from a linear or branched hydrocarbon, alcohol, anhydride, ether, ester, formate, carboxylic acid, carbamate, urea, amine, amide, sulfonate, sulfonic acid, sulfonamide, halide, saturated or unsaturated cyclic hydrocarbon, morpholine, pyrrolidine, piperidine, or mixtures thereof.

The present invention also relates to a polymer having at least one carbamate linkage prepared by: (i) reacting (a) at least one diisocyanate, polyisocyanate, or mixture thereof, having isocyanate groups, and (b) at least one fluorinated compound selected from the formula (2):

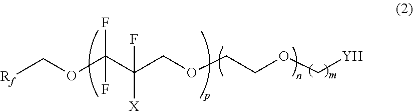

wherein R_{f} is C₁ to C₆ linear or branched fluoroalkyl; X is F or Cl; Y is O or a single bond; p is 0 to 1; m is 0 or 3 to 10, and n is 0 to 30; wherein at least one of p or m is a positive integer; provided that, if n is a positive integer, then p is 1; and provided that, if m is 0 then Y is a single bond, and if m is a positive integer then Y is O; and (ii) optionally reacting with (c) water, a linking agent, or a mixture thereof.

### DETAILED DESCRIPTION OF INVENTION

Hereinafter trademarks are designated by upper case.

The term “derivatives” is used to mean compounds of Formulae (3) to (11) as defined hereinafter.

The term “(meth)acrylates” refers to both acrylates and methacrylates.

The term “(meth)acrylamides” refers to both acrylamides and methacrylamides.

By the term “polyisocyanate” is meant di- and higher isocyanates and the term includes oligomers.

The present invention relates to polymers made from partially fluorinated alcohols or functionalized derivatives. A starting material useful for forming the partially fluorinated alcohols is a compound of formula (1):

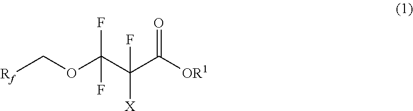

wherein R_{f} is C₁ to C₆ linear or branched fluoroalkyl, X is F or Cl, and R¹ is H, CH₃, or CH₂CH₃. Preferably, R_{f} is C₁ to C₃ linear fluoroalkyl. This compound is useful in the formation of a partially fluorinated alcohol, which can in turn be derivatized and used to produce polymeric materials.

The process used to prepare the compound of Formula (1), wherein R_{f} is C₁ to C₆ linear or branched fluoroalkyl and X is F or Cl, comprises a) contacting a alkali metal hydride with a fluorinated alcohol of formula R_{f}CH₂OH to produce a catalyst, b) contacting a symmetrical fluorinated carbonate of formula (R_{f}CH₂O)₂C(O), wherein R_{f} is C₁ to C₆ linear or branched fluoroalkyl, with CF₂═CFX, wherein X is F or Cl, in the presence of the catalyst to generate a reaction mixture, c) hydrolyzing the reaction mixture of step b) to form a compound of Formula (1) where R¹ is H, herein designated as Formula (1a),

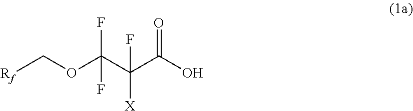

and d) optionally reacting the compound of Formula (1a) with methanol or ethanol to yield a compound of Formula (1). Preferred starting alcohols for step a) include those where R_{f} is C₁ to C₃ linear fluoroalkyl, or mixtures thereof. During step a), an alkali metal hydride of the formula WH_{g}, where W is an alkali metal and g is 1 to 2, is reacted with a fluorinated alcohol of formula R_{f}CH₂OH, wherein R_{f} is C₁ to C₆ linear or branched fluoroalkyl, to produce a catalyst of formula R_{f}CH₂O⁻W⁺.

The process for forming the carboxylic acids of formula (1a) includes producing a symmetrical fluorinated carbonate of formula (7):

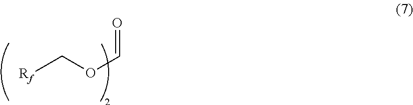

where R_{f} is as defined above, by reacting a fluorinated alcohol, such as 2,2,3,3,3-pentafluoropropanol, with phosgene, diphosgene, or triphosgene in a solvent system, such as pyridine and ether solution. Preferred starting alcohols for forming the symmetrical fluorinated carbonates of Formula (7) have the formula R_{f}CH₂OH, where R_{f} is C₁ to C₆ linear or branched fluoroalkyl, preferably C₁ to C₃ linear fluoroalkyl, or mixtures thereof. Preferably, the same starting alcohol used to form the compound of Formula (7) is also used in step a) to form the catalyst.

The corresponding symmetrical fluorinated carbonates of formula (7) are then reacted with tetrafluoroethylene or trifluorochloroethylene using catalytic amounts of an alkoxide generated in step a), such as R_{f}CH₂O—, to produce compounds of formula (8):

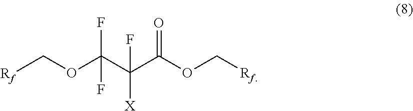

Compounds of formula (8) are then treated with caustic, such as aqueous sodium hydroxide, followed by an acid wash, such as with aqueous hydrochloric acid, to produce partially fluorinated carboxylic acids of formula (1a).

Partially fluorinated alkyl esters of Formula (1), where R¹ is CH₃, designated as Formula (1b), or where R¹ is CH₂CH₃, designated as Formula (1c), can be prepared by esterifying the partially fluorinated carboxylic acid compounds of formula (1a), with an alcohol such as, for example, methanol or ethanol:

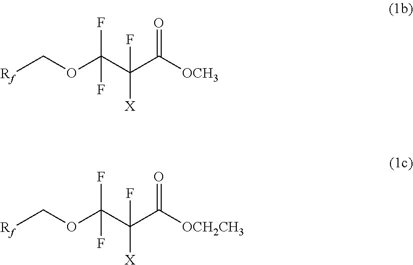

In another embodiment, partially fluorinated alkyl esters of Formula (1), where R¹ is CH₃ (Formula 1b) or CH₂CH₃ (Formula 1c), can be prepared by the insertion of tetrafluoroethylene or trifluorochloroethylene into a mixed partially fluorinated carbonate of Formula (9):

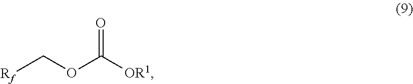

wherein R_{f} is C₁ to C₆ linear or branched fluoroalkyl and R¹ is CH₃ or CH₂CH₃, using catalytic amounts of an alkoxide such as R_{f}CH₂O⁻.

The partially fluorinated alkyl esters of Formula (1) can be reduced to form partially fluorinated alcohols useful in the invention.

Compounds of formula (9) can be prepared by reacting a fluorinated alcohol of formula R_{f}CH₂OH with an alkyl chloroformate and pyridine, followed by an acid wash and isolation. Preferred starting alcohols for forming the mixed partially fluorinated carbonate of Formula (9) have the formula R_{f}CH₂OH, where R_{f} is C₁ to C₆ linear or branched fluoroalkyl, preferably C₁ to C₃ linear fluoroalkyl, or mixtures thereof. The alkyl chloroformate is preferably C₁ to C₆ alkyl chloroformate, and more preferably methyl chloroformate.

In another embodiment, a partially fluorinated aldehyde of formula (10)

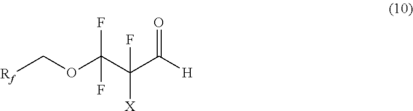

wherein R_{f} is C₁ to C₆ linear or branched fluoroalkyl, can be formed as a useful intermediate for producing a partially fluorinated alcohol. In this embodiment, the process for producing the compound of formula (10) comprises a) contacting an alkali metal hydride with a fluorinated alcohol of formula R_{f}CH₂OH to produce a catalyst R_{f}CH₂O⁻, b) contacting R_{f}CH₂OH with formic acid to produce a partially fluorinated formate of Formula (11):

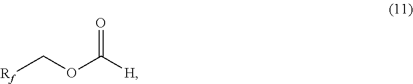

and
c) contacting the partially fluorinated formate with CF₂═CFX in the presence of the catalyst to form a partially fluorinated aldehyde. Preferably, R_{f} is linear C₁ to C₃ fluoroalkyl, or mixtures thereof.

Compounds of formula (11) can be prepared by reacting a fluorinated alcohol of formula R_{f}CH₂OH with formic acid under reflux conditions. Solvents known to those skilled in the art may be also be used throughout the process. In a preferred embodiment, the partially fluorinated formate is formed without the use of solvent.

The partially fluorinated alcohols useful in making the polymers of the invention are represented by formula (2):

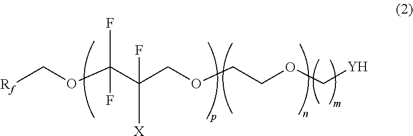

wherein R_{f} is C₁ to C₆ linear or branched fluoroalkyl; X is F or Cl; Y is O or a single bond; p is 0 to 1; m is 0 or 3 to 10; and n is 0 to 30; wherein at least one of p or m is a positive integer; provided that, if n is a positive integer, then p is 1; and provided that, if m is 0 then Y is a single bond, and if m is a positive integer then Y is O. Preferred fluorinated alcohols are those where R_{f} is C₁ to C₃ linear fluoroalkyl. Most preferably, the compound is selected from the formula (2) such that (1) p is 1, m is 0 or 3 to 8, and n is 0; (2) p is 0, m is 3 to 8, and n is 0; or (3) p is 1, m is 0, and n is 1 to 12.

In one embodiment, the partially fluorinated alcohols of formula (2) are made by a process comprising

a) contacting an alkali metal hydride of formula WH_{g}, where W is an alkali metal and g is 1 to 2, with a fluorinated alcohol of formula R_{f}CH₂OH, wherein R_{f} is C₁ to C₆ linear or branched fluoroalkyl, to produce a catalyst of formula R_{f}CH₂O⁻W⁺,

b) contacting R_{f}CH₂OH with (i) formic acid to produce a partially fluorinated formate, (ii) alkyl chloroformate to produce a mixed partially fluorinated carbonate, or (iii) phosgene, diphosgene, or triphosgene to produce a symmetrical partially fluorinated carbonate,

c) contacting the partially fluorinated formate of step (b)(i) or partially fluorinated carbonate of step (b)(ii) or (b)(iii) with CF₂═CFX, wherein X is F or Cl, in the presence of the catalyst of formula R_{f}CH₂O⁻W⁺ to yield, respectively, a partially fluorinated aldehyde (i), partially fluorinated ester (ii), or partially fluorinated carboxylic acid (iii),

d) contacting the partially fluorinated carboxylic acid of step (c)(iii) with an organic alcohol to form a partially fluorinated ester,

e) contacting (i) the partially fluorinated aldehyde of step (c)(i), (ii) the partially fluorinated ester of step (c)(ii), or (iii) the partially fluorinated ester of step (d) with a reducing agent to form the compound of formula (2) where p is 1 and n=m=0, designated as formula (2a)

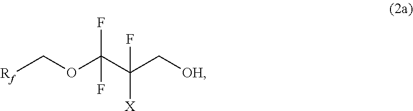

and

f) optionally contacting the compound of formula (2a) with an alcohol of the formula J(CH₂)ₜOH in the presence of a base, where J is a halogen and t is 3-10, or ethylene oxide in the presence of a catalyst, to form the compound of formula (2).

In the above process, R_{f} is preferably linear C₁ to C₃ fluoroalkyl, or mixtures thereof. The alkali metal hydride of step a) can be any alkali metal hydride conventionally used in the art, but is preferably selected from the group consisting of NaH, KH, and CaH₂; and the reducing agent of step e) can be any reducing agent conventionally used in the art but is preferably selected from the group consisting of LiAlH₄ and NaBH₄. Solvents known to those skilled in the art may be also be used throughout the process, including but not limited to ether.

Preferably, the same starting alcohol used to form the partially fluorinated formate of step (b)(i) or partially fluorinated carbonate of step (b)(ii) or (b)(iii) is also used in step a) to form the catalyst of formula R_{f}CH₂O⁻W⁺.

The formation of the partially fluorinated formate of step (b)(i) or partially fluorinated carbonate of step (b)(ii) or (b)(iii), and reduction of the partially fluorinated aldehyde of step (c)(i), the partially fluorinated ester of step (c)(ii), or the partially fluorinated ester of step (d) can be performed by conventional methods known to one of skill in the art. The intermediate compounds may be isolated prior to reaction. Preferably, steps c) and e) are performed as a semi-continuous process where the partially fluorinated aldehyde of step (c)(i) or partially fluorinated ester of step (c)(ii) is not isolated prior to performing step e). In another preferred embodiment, the partially fluorinated formate of step (b)(ii) is formed without the use of organic solvent. In another preferred embodiment, steps (c)(i), (c)(ii), (e)(i), and (e)(ii) take place at a temperature at or below −20° C., most preferably from −20 to −40° C.

Fluorinated alcohols of formula (2a) or R_{f}CH₂OH may be extended to further improve the fluorine efficiency of the molecules. These extended partially fluorinated alcohols are represented by Formulae (2) where p is 1 and m is a positive integer designated as formula (2b); Formulae (2) where p is 0 and m is positive integer designated as formula (2c); and Formula (2) where p is 1 and n is a positive integer designated as formula (2d):

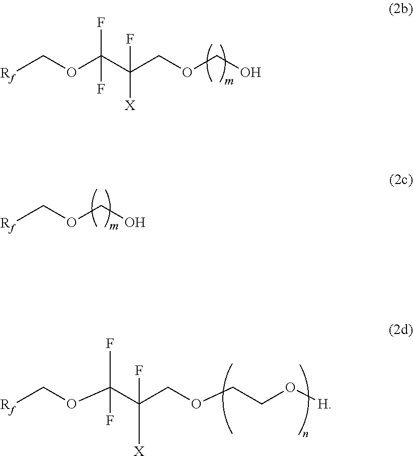

The compounds of Formula (2b) can be formed by the reaction of the partially fluorinated alcohol of Formula (2a) with an alcohol of the formula J(CH₂)ₜOH, where J is a halogen and t is 3 to 10, in the presence of a base. Similarly, the compounds of Formula (2c) can be formed by contacting an alcohol of the formula R_{f}CH₂OH, wherein R_{f} is C₁ to C₆ linear or branched fluoroalkyl, more preferably C₁ to C₃ linear fluoroalkyl, with an alcohol of formula J(CH₂)ₜOH, where J is a halogen and t is 3-10, in the presence of a base. In the compounds of Formulae (2b), m is preferably 3 to 8 and more preferably 3 to 6. In the compounds of Formula (2c), m is preferably 3 to 10, and more preferably 3 to 8. The base used to form the alcohol of formula (2b) or (2c) can be any base conventionally used in the art, but is preferably selected from the group consisting of NaH, KOH, NaOH, Na₂CO₃, and Cs₂CO₃.

The compounds of Formula (2d) can be prepared by reacting partially fluorinated alcohols of Formula (2a) with ethylene oxide in the presence of a catalyst. In the compounds of Formula (2d), n is 1 to 30 and preferably 1 to 12. The catalyst used to form the alcohol of formula (2d) can be any catalyst conventionally used in the art, but is preferably selected from the group consisting of NaH, KOH, NaOH, Cs₂CO₃, and a boron-based catalyst. The term “boron-based catalyst” is hereby defined as a mixture of trialkyl borate B(OR²⁰)₃ and a halide source LE, wherein R²⁰ is a linear, branched, cyclic, or aromatic hydrocarbyl group, optionally substituted, having from 1 to 30 carbon atoms; L is a cation of the alkali metals Na+, K+, Li+ or a cation of an alkyl tertiary amine or alkyl tertiary phosphorus; and E is fluoride, bromide, or iodide. Trialkyl borates are typically prepared in situ by reacting boric acid or sodium borohydride with the alcohol to be ethoxylated. The base compounds, as well as the starting materials for borate synthesis, are readily available from Sigma Aldrich, St. Louis, Mo. The borate/halide catalyst system is described in detail in U.S. Pat. No. 8,067,329, herein incorporated by reference.

It should be understood by one skilled in the art that mixtures of these reactions are also included, where both m and n are positive integers. For example, the ethoxylation of an alcohol of Formulae (2b) or (2c) would form extended partially fluorinated alcohols with further improved fluorine efficiency.

The invention also relates to a compound of Formula (3):

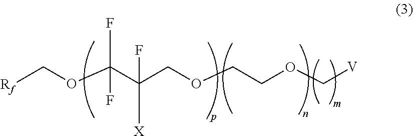

wherein R_{f} is C₁ to C₆ linear or branched fluoroalkyll X is F or Cl; V is —YC(O)CR²═CH₂, —YC(O)R¹⁹SH, or —YC(O)NHCH₂CH₂OC(O)CR²═CH₂; Y is O or a single bond; R² is independently selected from H or a C₁ to C₄ alkyl group; R¹⁹ is an alkylene of about 1 to about 10 carbon atoms; p is 0 to 1; m is 0 or 3 to 10; and n is 0 to 30; wherein at least one of p or m is a positive integer; provided that, if n is a positive integer, then p is 1; and provided that, if m is 0 then Y is a single bond, and if m is a positive integer then Y is O. Preferably, R_{f} is a linear C₁ to C₃ perfluoroalkyl.

Where V is —YC(O)CR²═CH₂ or —YC(O)NHCH₂CH₂OC(O)CR²═CH₂, the invention relates to partially fluorinated (meth)acrylate derivatives. The (meth)acrylate derivatives, where V is —YC(O)CR²═CH₂, can be prepared from the alcohols of Formula (2) by adding triethylamine and tetrahydrofuran, then reacting with acryloyl chloride or methacryloyl chloride by adding them dropwise in tetrahydrofuran. The solid is removed, typically by filtration, and washed with tetrahydrofuran, and then purified, usually by ether extraction and water-washing, concentrating and drying under vacuum.

Alternatively, the (meth)acrylate derivatives, where V is —YC(O)CR²═CH₂, can be prepared from the alcohols of Formula (2) by reacting with acrylic, methacrylic or chloroacrylic acid in the presence of an acid catalyst, such as toluenesulfonic acid, and a solvent, such as hexane, cyclohexane, heptane, octane, or toluene. The organic layer is washed with water, isolated, and then purified, typically by vacuum distillation. Optionally, inhibitors such as 4-methoxyphenol may be added during or after synthesis.

The partially fluorinated urethane (meth)acrylates, where V is —YC(O)NHCH₂CH₂OC(O)CR²═CH₂, are prepared from the alcohols of formula (2) by the reaction with corresponding 2-isocyanatoethyl(meth)acrylate in methylene chloride. The solid product is removed, typically by filtration and purified by repeated washing with a mixture of methylene chloride/hexane. Preferably, the product is formed without the use of solvent.

Where V is —YC(O)R¹⁹SH, the compounds are partially fluorinated mercaptoalkanoate compounds. The mercaptoalkanoate compounds can be prepared from the alcohols of Formula (2) by reacting with mercaptoalkanoic acid in the presence of an acid catalyst, such as toluenesulfonic acid, and a solvent, such as hexane, cyclohexane, heptane, octane, or toluene. The organic layer is washed with water, isolated, and then purified, typically by vacuum distillation.

The partially fluorinated (meth)acrylate compounds of Formula (3) are useful as monomers for producing copolymers, and the partially fluorinated mercaptoalkanoate compounds of Formula (3) are useful as chain transfer agents in polymerization reactions. The resulting polymers are useful for providing surface effects to a variety of substrates such as hard surfaces, textiles and fibrous substrates, and for producing superior film forming foams.

The polymers comprise the reaction product of: (a) a compound of Formula (3), or a mixture thereof: wherein R_{f} is C₁ to C₆ linear or branched fluoroalkyl; X is F or Cl; V is —YC(O)CR₂═CH₂, —YC(O)R¹⁹SH, or —YC(O)NHCH₂CH₂OC(O)CR²═CH₂; Y is O or a single bond; R² is independently selected from H or a C₁ to C₄ alkyl group; R¹⁹ is an alkylene of about 1 to about 10 carbon atoms; p is 0 to 1; m is 0 or 3 to 10, and n is 0 to 30; wherein at least one of p or m is a positive integer; provided that, if n is a positive integer, then p is 1; and provided that, if m is 0 then Y is a single bond, and if m is a positive integer then Y is O; and (b) at least one ethylenically unsaturated monomer having a functional group selected from a linear or branched hydrocarbon, alcohol, anhydride, ether, ester, formate, carboxylic acid, carbamate, urea, amine, amide, sulfonate, sulfonic acid, sulfonamide, halide, saturated or unsaturated cyclic hydrocarbon, morpholine, pyrrolidine, piperidine, or mixtures thereof.

The ethylenically unsaturated monomer (b) can be any monomer having an ethylenically unsaturated bond with a functional group described above, including but not limited to linear or branched alkyl (meth)acrylates, amino and diamino (meth)acrylates, alkoxylated (meth)acrylates, (meth)acylic acid, vinyl or vinylidene chloride, glycidyl (meth)acrylate, vinyl acetate, hydroxyalkylene (meth)acrylate, urethane or urea (meth)acrylates, (meth)acrylamides including N-methyloyl acrylamide, styrene, alpha-methylstyrene, chloromethyl-substituted styrene, ethylenediol di(meth)acrylate, 2-acrylamido-2-methyl-1-propane sulfonic acid (AMPS), maleic anhydride, and fluorinated (meth)acrylates 2-[methyl[(3,3,4,4,5,5,6,6,7,7,8,8,8tridecafluorooctyl)sulfonyl]amino]ethyl acrylate having the structure CH₂═CH—COOO—C₂H₄—N(CH₃)—SO₂—C₂H₄—C₆F₁₃, 2-[methyl[(3,3,4,4,5,5,6,6,6-nonfluorohexyl)sulfonyl]amino]ethyl acrylate, 2-[methyl[(3,3,4,4,5,5,6,6,7,7,8,8,8-tridecafluorooctyl)sulfonyl]amino]ethyl methacrylate, and 2-[[(3,3,4,4,5,5,6,6,7,7,8,8,8-tridecafluorooctyl)sulfonyl]amino]ethyl methacrylate.

The polymers can be useful for imparting surface effects, wherein compound (a) of Formula (3) is reacted with (b) a monomer selected from Formula (4) or Formula (5), or a mixture thereof:

CH₂═C(R³)COZ(CH₂)_{q}(CHR³)ᵢNR⁴R⁵ Formula (4)

CH₂═C(R³)NR⁶R⁷ Formula (5)

wherein R³ is independently selected from H or CH₃; R⁴ and R⁵ are each independently C₁ to C₄ alkyl, hydroxyethyl, or benzyl; or R⁴ and R⁵ together with the nitrogen atom form a morpholine, pyrrolidine, or piperidine ring; R⁶ and R⁷ are each independently selected from H or C₁ to C₄ alkyl; Z is —O— or —NR⁸— wherein R⁸ is H or C₁-C₄ alkyl; i is 0 to 4, and q is 1 to 4; provided that the nitrogen bonded to R⁴ and R⁵ is from about 0% to 100% salinized, quaternized, or present as amine oxide; and (c) a monomer of Formula (6), or a mixture thereof:

CH₂═CR⁹(R¹⁰)ₑ—COOH Formula (6)

wherein R⁹ is independently selected from H or CH₃; R¹⁰ is CO(CH₂)₅, CO(O)(CH₂)₂, C₆H₄CHR⁹, or C(O)NR⁹R¹¹; R¹¹ is C₆H₄OCH₂, (CH₂)_{d}, or C(CH₃)₂CH₂; d is 1 to about 10; and e is 0 or 1. Additional monomers may also be copolymerized, selected from those described above for ethylenically unsaturated monomer (b).

In one preferred embodiment, the polymer above employs a compound of Formula (3) such that V is —YC(O)CR²═CH₂ or —YC(O)NHCH₂CH₂OC(O)CR²═CH₂. Preferably, the compounds (a), (b), and (c) are reacted in the following percentages by weight: from about 30% to about 90% of a compound of Formula (3), from about 9% to about 40% of a monomer of Formula (4), and from about 1% to about 30% of a monomer of Formula (6), wherein the sum of the monomer components equals 100%.

The copolymers of this preferred embodiment can be synthesized by any means known to one skilled in the art. The copolymer may be optionally partially or completely salinized or quarternized by conventional techniques known to those skilled in the art, with the degree of salinization or quarternization preferably from about 50% to about 100%. Preferably, the copolymers are synthesized by combining the monomers in a solvent system, such as isopropyl alcohol and methyl isobutyl ketone, heating the mixture to the activation temperature of an initiator, slowly introducing an initiator into the monomer mixture, and allowing the copolymerization to propagate. The polymer mixture is then contacted with an aqueous salinization solution, such as acetic acid solution, and the organic solvents are removed, preferably by distillation. The final product is an aqueous emulsion.

In another preferred embodiment, the polymer above employs a compound of Formula (3) such that V is —YC(O)R¹⁹SH. Preferably, the compounds (a), (b), and (c) are reacted in the following percentages by weight: from about 4% to about 40% of a compound of Formula (3), from about 30% to about 95% of a monomer of Formula (5), and from about 1% to about 30% of a monomer of Formula (6), wherein the sum of the monomer components equals 100%. The polymers of this preferred embodiment can be synthesized by any means known to one skilled in the art. Preferably, the monomer(s) are charged with the partially fluorinated mercaptoalkanoate in a solvent, such as acetonitrile, and purged with nitrogen. The mixture is heated to the activation temperature of an initiator, and water and initiator are charged into the mixture. Additional monomer may be charged at this time as well. The mixture is heated to allow the polymerization to propagate, and the organic solvent is removed, preferably by distillation. The final product is an aqueous emulsion.

Another polymer is useful, having at least one carbamate linkage prepared by: (i) reacting (a) at least one diisocyanate, polyisocyanate, or mixture thereof, having isocyanate groups, and (b) at least one fluorinated compound selected from the formula (2) wherein R_{f} is C₁ to C₆ linear or branched fluoroalkyl; X is F or Cl; Y is O or a single bond; p is 0 to 1; m is 0 or 3 to 10; and n is 0 to 30, wherein at least one of p or m is a positive integer; provided that, if n is a positive integer, then p is 1; and provided that, if m is 0 then Y is a single bond, and if m is a positive integer then Y is O; and (ii) optionally reacting with (c) water, a linking agent, or a mixture thereof. Preferred embodiments include polymers, where R_{f} is C₁ to C₃ linear fluoroalkyl, said fluorinated compound reacts with about 5 mol % to about 90 mol % of said isocyanate groups, said non-fluorinated compound reacts with about 0.1 mol % to about 60 mol % of said isocyanate groups, the linking agent is a diamine or polyamine, and/or the polymer is in the form of an aqueous dispersion or solution.

The diisocyanate or polyisocyanate reactant used to produce the polymer containing at least one carbamate linkage adds to the branched nature of the polymer. Any polyisocyanate having predominately two or more isocyanate groups, or any isocyanate precursor of a polyisocyanate having predominately two or more isocyanate groups, is suitable for use in this invention. For example, hexamethylene diisocyanate homopolymers are suitable for use herein and are commercially available. It is recognized that minor amounts of diisocyanates may remain in products having multiple isocyanate groups. An example of this is a biuret containing residual small amounts of hexamethylene diisocyanate.

Also suitable for use as the polyisocyanate reactant are hydrocarbon diisocyanate-derived isocyanurate trimers. Preferred is DESMODUR N-3300 (a hexamethylene diisocyanate-based isocyanurate available from Bayer Corporation, Pittsburgh, Pa.). Other triisocyanates useful for the purposes of this invention are those obtained by reacting three moles of toluene diisocyanate with 1,1,1-tris-(hydroxymethyl)ethane or 1,1,1-tris(hydroxymethyl)propane. The isocyanurate trimer of toluene diisocyanate and that of 3-isocyanatomethyl-3,4,4-trimethylcyclohexyl isocyanate are other examples of triisocyanates useful for the purposes of this invention, as is methane-tris-(phenylisocyanate). Precursors of polyisocyanate, such as diisocyanate, are also suitable for use in the present invention as substrates for the polyisocyanates. DESMODUR N-3600, DESMODUR Z-4470, and DESMODUR XP 2410, from Bayer Corporation, Pittsburgh, Pa., and bis-(4-isocyanatocylohexyl)methane are also suitable in the invention.

Preferred polyisocyanate reactants are the aliphatic and aromatic polyisocyanates containing biuret structures, or polydimethyl siloxane containing isocyanates. Such polyisocyanates can also contain both aliphatic and aromatic substituents.

Particularly preferred as the polyisocyanate reactant for all the embodiments of the invention herein are hexamethylene diisocyanate homopolymers commercially available, for instance as DESMODUR N-100, DESMODUR N-75 and DESMODUR N-3200 from Bayer Corporation, Pittsburgh, Pa.; 3-isocyanatomethyl-3,4,4-trimethylcyclohexyl isocyanate available, for instance as DESMODUR I (Bayer Corporation); bis-(4-isocyanatocylohexyl)methane available, for instance as DESMODUR W (Bayer Corporation) and diisocyanate trimers of formulae (12a), (12b), (12c) and (12d):

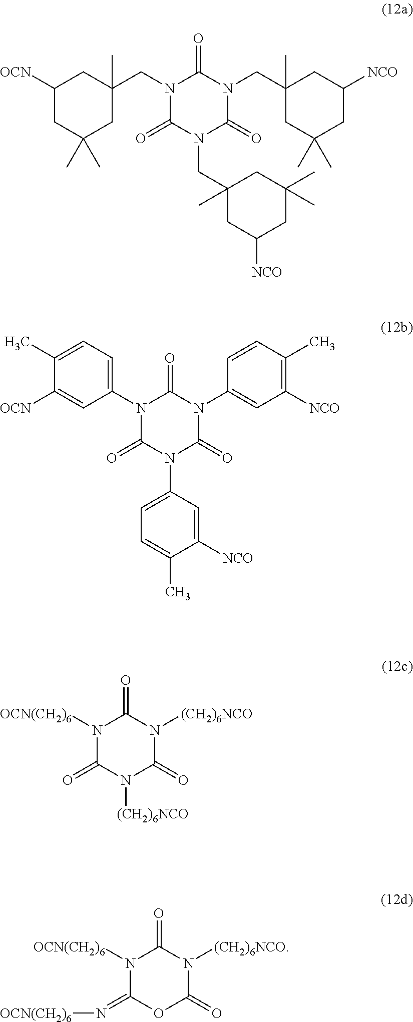

The diisocyanate trimers (12a-d) are available, for instance as DESMODUR Z4470, DESMODUR IL, DESMODUR N-3300, and DESMODUR XP2410, respectively, from Bayer Corporation.

To make the polymers having at least one carbamate linkage of the present invention, a compound of Formula (2) is reacted with a polyisocyanate to produce a fluoropolymer. The fluoropolymer is typically prepared by charging a reaction vessel with the polyisocyanate, the above fluoroalcohol, fluorothiol or fluoroamine, or mixture thereof, and optionally a non-fluorinated organic compound. The order of reagent addition is not critical. The specific weight of the polyisocyanate and other reactants charged is based on their equivalent weights and on the working capacity of the reaction vessel, and is adjusted so that alcohol, thiol or amine, is consumed in the first step. The charge is agitated and temperature adjusted to about 40-70° C. Typically a catalyst, such as a titanium chelate or iron trichloride in an organic solvent, is then added and the temperature is raised to about 80-100° C. Alternatively, the catalyst may be included in the original charge, and the fluorinated alcohol may be added slowly after initial heating. After holding for several hours, additional solvent and water, a linking agent, or a combination thereof, is added, and the mixture allowed to react for several more hours or until all of the isocyanate has been reacted. More water can then be added along with surfactants, if desired, and stirred until thoroughly mixed. Following homogenization, the organic solvent can be removed by evaporation at reduced pressure, and the remaining aqueous solution of the fluoropolymer used as is or subjected to further processing.

Preferably, step (i) further comprises reacting (d) a non-fluorinated organic compound selected from the group consisting of Formula (13)

R¹²—(R¹³)ₖ-QH (13)

wherein R¹² is a C₁-C₁₈ alkyl, a C₁-C₁₈ omega-alkenyl radical or a C₁-C₁₈ omega-alkenoyl; k is 0 or 1; Q is —O—, —S—, or —NR¹⁷— in which R¹⁷ is H or alkyl containing 1 to 6 carbon atoms; and R¹³ is selected from the group consisting of

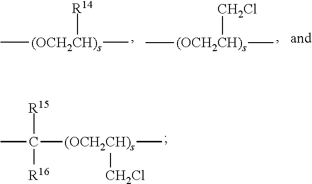

wherein R¹⁴, R¹⁵ and R¹⁶ are each independently H or C₁ to C₆ alkyl, and s is an integer of 1 to 50. Preferably, the compound of formula (13) comprises a hydrophilic water-solvatable material comprising at least one hydroxy-terminated polyether of formula (14):

R¹⁸—O(CH₂CH₂O)ⱼ—(CH₂CH(CH₃)O)ⱼ₁—CH₂CH₂O)ⱼ₂—H Formula (14)

wherein R¹⁸ is a monovalent hydrocarbon radical containing from about one to about six aliphatic or alicyclic carbon atoms; j is a positive integer, and j1 and j2 are each independently a positive integer or zero; said polyether having a weight average molecular weight up to about 2000.

Subscripts j and j2 are independently an average number of repeating oxyethylene groups, and j1 is an average number of repeating oxypropylene groups, respectively. When j1 and j2 are zero, Formula (14) designates an oxyethylene homopolymer. When j1 is a positive integer and j2 is zero, Formula (14) designates a block or random copolymer of oxyethylene and oxypropylene. When j1 and j2 are positive integers, Formula (14) designates a triblock copolymer designated PEG-PPG-PEG (polyethylene glycol-polypropylene glycol-polyethylene glycol) More preferably, the hydrophilic, water-solvatable components are the commercially available methoxypolyethylene glycols (MPEG's), or mixtures thereof, having an average molecular weight equal to or greater than about 200, and most preferably between 350 and 2000. Also commercially available, and suitable for the preparation of the polyfluoro organic compounds of the present invention, are butoxypolyoxyalkylenes containing equal amounts by weight of oxyethylene and oxypropylene groups (Union Carbide Corp. 50-HB Series UCON Fluids and Lubricants) and having an average molecular weight greater than about 1000.

The non-fluorinated compound of formula R¹²—(R¹³)ₖ-QH is reacted in step (i) with the polyisocyanate and fluorinated compound of formula (2) as described above, prior to the reaction with water, linkage agent, or a mixture thereof. This initial reaction is conducted so that less than 100% of the polyisocyanate groups are reacted. Following the initial reaction, water, linkage agent, or a mixture thereof, is added. The addition of water or linkage agent completely reacts all of the residual isocyanate groups and eliminates a further purification step that would be needed if other reactants were used at a ratio sufficient to react with 100% of the isocyanate groups. Further, this addition greatly increases the molecular weight of the polymers and assures proper mixing if more than one reactant is used in the first step of the polymer preparation, i.e., if a water solvatable component is added, it is likely that at least one unit will be present in each polymer.

Linking agents useful in forming polymers of the invention organic compounds have two or more Zerewitinoff hydrogen atoms (Zerevitinov, Th., Quantitative Determination of the Active Hydrogen in Organic Compounds, Berichte der Deutschen Chemischen Gesellschaft, 1908, 41, 2233-43). Examples include compounds that have at least two functional groups that are capable of reacting with an isocyanate group. Such functional groups include hydroxyl, amino and thiol groups. Examples of polyfunctional alcohols useful as linking agents include: polyoxyalkylenes having 2, 3 or 4 carbon atoms in the oxyalkylene group and having two or more hydroxyl groups, for instance, polyether diols such as polyethylene glycol, polyethylene glycol-polypropylene glycol copolymers, and polytetramethylene glycol; polyester diols, for instance, the polyester diols derived from polymerization of adipic acid, or other aliphatic diacids, and organic aliphatic diols having 2 to 30 carbon atoms; non-polymeric polyols including alkylene glycols and polyhydroxyalkanes including 1,2-ethanediol, 1,2-propanol diol, 3-chloro-1,2-propanediol, 1,3-propanediol, 1,3-butanediol, 1,4-butanediol, 2,2-dimethyl-1,3-propanediol, 1,2-, 1,5-, and 1,6-hexanediol, 2-ethyl-1,6-hexanediol, 1,8-octanediol, 1,10-decanediol, glycerine, trimethylolethane, trimethylolpropane, 2-ethyl-2-(hydroxymethyl)-1,3-propanediol, 1,2,6-hexanetriol, and pentaerythritol.

Preferred polyfunctional amines useful as linking agents include: amine terminated polyethers such as, for example, JEFFAMINE D400, JEFFAMINE ED, and JEFFAMINE EDR-148, all from Huntsman Chemical Company, Salt Lake City, Utah; aliphatic and cycloaliphatic amines including amino ethyl piperazine, 2-methyl piperazine, 4,4′-diamino-3,3′-dimethyl dicyclohexylmethane, 1,4-diaminocyclohexane, 1,5-diamino-3-methylpentane, isophorone diamine, ethylene diamine, diethylene triamine, triethylene tetraamine, triethylene pentamine, ethanol amine, lysine in any of its stereoisomeric forms and salts thereof, hexane diamine, and hydrazine piperazine; and arylaliphatic amines such as xylylenediamine and a,a,a′,a′-tetramethylxylylenediamine.

Mono- and di-alkanolamines that can be used as linking agents include: monoethanolamine, monopropanolamine, diethanolamine, dipropanolamine, and the like.

The polymers useful for providing surface effects, including those made from ethylenically unsaturated monomers and those from polyisocyanate reactions, are useful in improving the surface effects of various foam formulations, coating compositions and treated substrates. The polymers useful for providing surface effects produce superior surface altering performance, such as, but not limited to wetting, leveling, resistance to blocking, oil repellency, and dirt pickup resistance, of coating compositions while requiring less fluorine, and less fluorinated starting material compared to the prior art compositions. The partially fluorinated polymers may also provide surface tension lowering for applications such as aqueous film forming foams, often used to extinguish hydrocarbon fuel fires. This improved performance results in a reduced cost of raw materials and manufacturing as well as decreases cycle time.

Typical substrates include a wide variety of surfaces on which coating compositions are normally used. These include various construction materials, typically hard surfaced materials. The hard surface substrates include porous and non-porous mineral surfaces, such as glass, stone, masonry, concrete, unglazed tile, brick, porous clay and various other substrates with surface porosity. Specific examples of such substrates include unglazed concrete, brick, tile, stone including granite, limestone and marble, grout, mortar, statuary, monuments, wood, composite materials such as terrazzo, and wall and ceiling panels including those fabricated with gypsum board. In addition plastics, metals, ceramics, and other hard surfaces are included in the present invention. These are used in the construction of buildings, siding, roads, parking ramps, driveways, floorings, fireplaces, fireplace hearths, counter tops, walls, ceilings, decks, patios, furniture, fixtures, appliances, molded articles, shaped articles, decorative articles, and other items used in interior and exterior applications.

Other substrates include fibrous substrates. Most any fibrous substrate is suitable for treatment by the methods of the present invention. Such substrates include fibers, yarns, fabrics, fabric blends, textiles, carpet, rugs, nonwovens, leather and paper. The term “fiber” includes fibers and yarns, before and after spinning, of a variety of compositions and forms, and includes pigmented fibers and pigmented yarns. By “fabrics” is meant natural or synthetic fabrics, or blends thereof, composed of fibers such as cotton, rayon, silk, wool, polyester, polypropylene, polyolefins, nylon, and aramids such as “NOMEX” and “KEVLAR”. By “fabric blends” is meant fabric made of two or more different fibers. Typically these blends are a combination of at least one natural fiber and at least one synthetic fiber, but also can be a blend of two or more natural fibers and/or of two or more synthetic fibers.

It is desirable to have new, more selective chemistry, which provides a more fluorine efficient building block for use as an intermediate, to produce fluorinated polymers providing surface effects to substrates and foams treated therewith. The present invention solves this problem. Included are lower fluorine containing starting alcohols, the process for making lower fluorine containing starting alcohols, derivatives made from the lower fluorine containing starting alcohols, and polymers made from the lower fluorine containing starting alcohols and derivatives. The derivatives and polymers of the present invention serve to improve surfactant performance, such as lower the surface tension of a coating composition or foam composition, while using less fluorine. They can also impart surface effects, such as water and oil repellency, to coated surfaces.

### Materials and Test Methods

### Test Methods

### Test Method 1—Surface Tension Measurement

Surface tension was measured according to the American Society for Testing and Materials ASTM # D1331-56, using the Wilhelmy plate method on a KRUSS K11 Version 2.501 tensiometer (KRUSS USA, 5 Matthews NC) in accordance with instructions with the equipment. A vertical plate of known perimeter was attached to a balance, and the force due to wetting was measured. Each example to be tested was prepared as an aqueous solution, based on solids content, of the additive in deionized water. Several different concentrations were prepared. Ten replicates were tested of each dilution, and the following machine settings were used: Method: Plate Method SFT; Interval: 1.0 s; Wetted length: 40.2 mm; 15 reading limit: 10; Minimum standard deviation: 2 dynes/cm; and Gr. accellearation: 9.80665 m/s².

Results were in dynes/cm (mN/m) with a Standard Deviation of less than 1 dyne/cm. The tensiometer was used according to the manufacturer's recommendations. A stock solution was prepared for the highest concentration of surfactant to be analyzed. The concentration of the solution was by weight percent of the surfactant in deionized water. The solutions were stirred overnight (for approximately 12 hours) to ensure complete mixing. Lower concentrations of the stock solution for each example were made by diluting the original stock solution. Lower surface tension results indicate superior performance.

### Test Method 2—Water and Oil Beading Test

The substrate was first wiped clean using a Sontara® SPS™ wipe and water. After drying, one coat of sealer was applied using a ½ inch bristle brush. The amount of sealer applied was based on the rates below. The samples cured for at least 24 hours before undergoing any performance tests.

Special Case: Granite and Marble

One hour after the sample was applied to the substrate, the tile was buffed with a Sontara® SPS™ wipe to remove excess sealer and restore shiny appearance to the tile.

TABLE 1
Application Rate of Sealers

| Substrate | Application Rate (g/m²) |
|---|---|
| Limestone, Granite, | 100 |
| Marble, Travertine, Slate | |
| Saltillo | 200 |
| Concrete | 300 |

A drop was placed onto the substrate. The degree of beading was then scored by matching the contact angle to the appropriate score from Table 2. A higher contact angle demonstrates superior performance.

TABLE 2
Ratings for Water and Oil Beading

| Rating | Visible Contact Angle |
|---|---|
| 5 | 100-120° |
| 4 | 75-90° |
| 3 | 45-75° |
| 2 | 25-45° |
| 1 | 10-25° |
| 0 | <10° |

### Test Method 3—Stain Resistance Test

Small amounts of stains, including ketchup, mustard, coffee, oil, red wine, and blue ink, were placed on the tile surface and allowed to sit uncovered for 24 hours. The stains were removed using a 1% soap solution. The stains remaining after cleaning were rated according to Table 3.

TABLE 3
Ratings for Stain Testing

| Rating | Description |
|---|---|
| 0 | No stain |
| 1 | Very light stain |
| 2 | Light stain |
| 3 | Moderate stain |
| 4 | Heavy stain |

For each sealer sample, the ratings for each stone sample were summed to give a composite rating for that stone (maximum score=6 stains×4=24). An additional score for the width of the ink stain was added (1-3, with 3 being the widest). Total stain score maximum was 27. Lower scores indicates better stain protection.

### Test Method 4—Wetting/Leveling Test

To test the performance of the samples in their wetting and leveling ability, the samples were added to a floor polish (RHOPLEX 3829, Formulation N-29-1, available from The Dow Chemical Company, Philadelphia, Pa.]) and applied to half of a thoroughly cleaned 12 inch×12 inch (30.36 cm×30.36 cm) vinyl tile (available from Interfuse Vinyl Tiles by Estrie, Sherbrooke, QC Canada). The tiles are thoroughly cleaned by wetting the tiles, adding a powdered oxygen bleach cleanser and scrubbing using a green SCOTCH-BRITE scouring pad, available from 3M Company, St. Paul Minn.). This scrubbing procedure was used to remove the pre-existing coating on the tiles. The tiles initially have a uniform shiny finish; a uniform dull finish indicates coating removal. The tiles are then air-dried overnight. A 1 wt % solution of the surfactant to be tested was prepared by dilution in deionized water. Following the resin manufacturer protocols, a 100 g portion of the RHOPLEX 3829, N-29-1 formulation was prepared, followed by addition of 0.75 g of the 1 wt % surfactant solution, to provide a test floor polish.

The test floor polish was applied to the tile by placing 3 mL portion of the test polish in the center of the tile, and spreading from top to bottom using a cheesecloth applicator, and finally placing a large “X” across the tile, using the applicator. The “X” subsequently provides visual evidence of leveling at the rating step. The applicator was prepared from a two-layer 18×36 inch (46×91 cm) sheet of cheesecloth (from VWR, West Chester Pa.), folded twice into an eight-layer pad. One corner of the pad was then used as the applicator. The tile was allowed to dry for 30 min. and a total of 5 coats (Coating #s 1-5) were applied and dried, with the X test performed after each coating had been dried. After each coat, the tile was rated on a 1 to 5 scale (1 being the worst, 5 the best) on the surfactant's ability to promote wetting and leveling of the polish on the tile surface. The rating is determined using the Tile Rating Scale shown in Table 4, based on comparison of a tile treated with the floor polish that contains no added surfactant. A higher rating demonstrates superior performance.

TABLE 4
Visual Tile Rating Scale for Leveling

| Rating | Description |
|---|---|
| 1 | Uneven surface coverage of the film, |
| | significant streaking and surface defects |
| 2 | Numerous surface defects and streaks are evident |
| | but, generally, film coats entire tile surface |
| 3 | Visible streaking and surface defects, |
| | withdrawal of the film from the edges of the tile |
| 4 | Minor surface imperfections or streaking |
| 5 | No visible surface defects or streaks |

### Materials

Unless otherwise noted, all of the chemicals used herein are commercially available from Sigma Aldrich, St. Louis, Mo.

2,2,3,3,3-pentafluoropropanol is commercially available from Oakwood Products Inc.
2,2,3,3,4,4,4-heptafluorobutanol is commercially available from Oakwood Products Inc.
Triphosgene is commercially available from TCI America.
Phosphorus Pentoxide is commercially available from Filo Chemical or from Changzhou Qishuyan Fine Chemical CO., LTD.

### EXAMPLES

### Compound 1

Example 1 illustrates the preparation of bis(2,2,3,3,3-pentafluoropropyl) carbonate and the subsequent preparation of 2,2,3,3-tetrafluoro-3-(2,2,3,3,3-pentafluoropropoxy)propanoic acid. Triphosgene (24.5 g, 82.5 mmol) and anhydrous diethyl ether (˜400 mL) were added to a 1-L 4-neck flask. The mixture was cooled to 0° C., and 2,2,3,3,3-pentafluoropropanol (75 g, 0.50 mol) was added. The mixture was stirred for 30 minutes. Pyridine (40.0 g, 0.51 mol) was then slowly added to the mixture via addition funnel. The resultant mixture was then gently refluxed for 1 hour. The solution was filtered to remove white solids and washed with dilute hydrochloric acid solution. The solution was then vacuum distilled to remove ether resulting in bis(2,2,3,3,3-pentafluoropropyl) carbonate (CF₃CF₂CH₂O)₂CO (71 g, 88% yield).

A catalyst was first prepared by slow addition of 2,2,3,3,3-pentafluoropropan-1-ol (15.0 g, 100 mmol) to a suspension of sodium hydride (60% in mineral oil, 6.0 g, 150 mmol) in anhydrous tetrahydrofuran (300 mL) in a 500-mL flask. The resultant mixture was stirred for 15 minutes, transferred into a Hastelloy vessel (1 L), and cooled to −20° C. The bis(2,2,3,3,3-pentafluoropropyl) carbonate, (CF₃CF₂CH₂O)₂CO, (115 g, 353 mmol) was then added to the vessel. The vessel was pressurized with tetrafluoroethylene (60 g, 600 mmol), and the contents were warmed to room temperature and agitated for 6 hours. The reaction mixture was then treated with a solution of NaOH (15 g, 375 mmol) in water (100 mL). Tetrahydrofuran and water were removed to vacuum, and the resultant solids were dissolved by addition of 3.0 M hydrochloric acid (400 mL). The organic phase was separated to yield 2,2,3,3-tetrafluoro-3-(2,2,3,3,3-pentafluoropropoxy)propanoic acid C₂F₅CH₂OCF₂CF₂C(O)OH (60 g, 58% yield).

### Compound 2

Compound 2 illustrates the preparation of an ethyl ester of Compound 1. 2,2,3,3-tetrafluoro-3-(2,2,3,3,3-pentafluoropropoxy)propanoic acid (65 g, 220 mmol), ethanol (50 mL, excess), and concentrated sulfuric acid (50 g) were added to a 250 ml, round bottom flask. The resultant mixture was refluxed for three hours under atmosphere of nitrogen. The product mixture was slowly added to water (400 mL), the organic layer was separated, washed with water (2×50 mL), and dried over magnesium sulfate to yield ethyl 2,2,3,3-tetrafluoro-3-(2,2,3,3,3-pentafluoropropoxyl)propanoate C₂F₅CH₂OCF₂CF₂C(O)OCH₂CH₃ (70 g, 98% yield).

### Compound 3

Compound 3 illustrates the preparation of 2,2,3,3-tetrafluoro-3-(2,2,3,3,3-pentafluoropropoxyl)propan-1-ol from the ethyl ester in Compound 2. Lithium aluminum hydride (5.2 g, 137 mmol) and anhydrous ether (100 mL) were added to a 250-mL round bottom flask, and the mixture was cooled to 5° C. Ethyl 2,2,3,3-tetrafluoro-3-(2,2,3,3,3-pentafluoropropoxyl)propanoate (77 g, 240 mmol) was added dropwise, keeping the temperature between 5 and 20° C. The mixture was then washed with diluted hydrochloric acid solution, and the organic phase was separated. The organic phase was purified via distillation to yield 2,2,3,3-tetrafluoro-3-(2,2,3,3,3-pentafluoropropoxyl)propan-1-ol C₂F₅CH₂OCF₂CF₂CH₂OH (57 g, 85% yield).

### Compound 4

Compound 4 illustrates the preparation of 3-(2,2,3,3,4,4,4-heptafluorobutoxyl)propan-1-ol from 2,2,3,3,4,4,4-heptafluorobutan-1-ol. Sodium hydride (60% in mineral oil, 5.0 g, 124 mmol) and anhydrous tetrahydrofuran (80 mL) were charged into a 250-mL flask, and 2,2,3,3,4,4,4-heptafluorobutan-1-ol (22.0 g, 110 mmol) was slowly added. Next, 3-bromopropan-1-ol (10.5 g, 76 mmol) was added, and the resultant mixture was heated at 50° C. for 3 hours. The reaction mixture was washed with 0.5 M solution of aqueous HCl (100 mL), and the organic layer was isolated. The organic layer was distilled to yield 3-(2,2,3,3,4,4,4-heptafluorobutoxyl)propan-1-ol C₃F₇CH₂OCH₂CH₂CH₂OH (10 g, or 51% yield).

### Compound 5

Compound 5 illustrates the preparation of 6-(2,2,3,3,4,4,4-heptafluorobutoxyl)hexan-1-ol from 2,2,3,3,4,4,4-heptafluorobutan-1-ol. Sodium hydride (60% in mineral oil, 6.0 g, 150 mmol) and anhydrous monoglyme (100 mL) were charged into a 250-mL flask, and 2,2,3,3,4,4,4-heptafluorobutan-1-ol (30.0 g, 150 mmol) was slowly added. Next, 6-bromohexan-1-ol (21.0 g, 116 mmol) was added, and the resultant mixture was heated at reflux for 4 hours. The reaction mixture was washed with a 1 M solution of aqueous HCl (100 mL) and the organic layer was isolated. The organic layer was distilled to yield 6-(2,2,3,3,4,4,4-heptafluorobutoxyl)hexan-1-ol C₃F₇CH₂O(CH₂)₆OH (20.6 g, 59% yield).

### Compound 6

Compound 6 illustrates the preparation of 8-(2,2,3,3,4,4,4-heptafluorobutoxyl)octan-1-ol from 2,2,3,3,4,4,4-heptafluorobutan-1-ol. Cesium carbonate (13 g, 40 mmol) and anhydrous diglyme (80 mL) were charged into a 250-mL flask, and 2,2,3,3,4,4,4-heptafluorobutan-1-ol (16.0 g, 80 mmol) was slowly added. The resultant mixture was heated to 125° C. Then, 8-chlorooctan-1-ol (12 g, 73 mmol) was added, and the mixture was stirred at 125° C. After 4 hours, additional cesium carbonate (13 g, 40 mmol) was added, and heating resumed for an additional 20 hours at 125° C. After that, the reaction mixture was filtered and washed with 0.5 M solution of aqueous HCl (100 mL) and the organic layer was isolated. The organic material was distilled to yield 8-(2,2,3,3,4,4,4-heptafluorobutoxyl)octan-1-ol C₃F₇CH₂O(CH₂)₈OH (8.4 g, 29% yield).

### Compound 7

Compound 7 illustrates the preparation of 3-(2,2,3,3-tetrafluoro-3-(2,2,3,3,3-pentafluoropropoxyl)propoxy)-propan-1-ol from the alcohol in Compound 3. Sodium hydride (60% in mineral oil, 4.4 g, 110 mmol) and anhydrous tetrahydrofuran (80 mL) were charged into a 250-mL flask, and 2,2,3,3-tetrafluoro-3-(2,2,3,3,3-pentafluoropropoxyl)propan-1-ol (18.0 g, 64 mmol) was slowly added. Then, 3-bromopropan-1-ol (8.0 g, 58 mmol) was added, and the resultant mixture was heated at 60° C. for 4 hours. The mixture was washed with 0.5 M solution of aqueous HCl (100 mL), and the organic layer was isolated. The organic material was distilled to yield 3-(2,2,3,3-tetrafluoro-3-(2,2,3,3,3-pentafluoropropoxyl)propoxy)-propan-1-ol C₂F₅CH₂OCF₂CF₂CH₂O(CH₂)₃OH (8.5 g, 43% yield).

### Compound 8

Compound 8 illustrates the preparation of 3-(2,2,3,3,4,4,4-heptafluorobutoxyl)propyl 3-mercaptopropanoate from the alcohol in Compound 4. Cyclohexane (˜70 mL), 3-(2,2,3,3,4,4,4-heptafluorobutoxyl)propan-1-ol (10 g, 38.7 mmol), 3-mercaptopropanoic acid (4.3 g, 40.5 mmol), and toluenesulfuric acid (0.2 g) were charged into a 250-mL flask equipped with a Dean-Stark condenser, and the resultant mixture was heated at reflux for 3 hours. The mixture was washed with water (100 mL), the organic phase was isolated, and cyclohexane was removed under reduced pressure. The organic material was distilled to yield 3-(2,2,3,3,4,4,4-heptafluorobutoxyl)propyl 3-mercaptopropanoate C₃F₇CH₂O(CH₂)₃OC(O)CH₂CH₂SH (11.4 g, 85% yield).

### Compound 9

Compound 9 illustrates the preparation of 6-(2,2,3,3,4,4,4-heptafluorobutoxyl)hexyl 3-mercaptopropanoate from the alcohol in Compound 5. The procedure of Compound 8 was performed, except that 6-(2,2,3,3,4,4,4-heptafluorobutoxyl)hexan-1-ol (11.2 g, 37 mmol), 3-mercaptopropanoic acid (5.0 g, 47 mmol), and toluenesulfuric acid (0.2 g) were reacted. Pure 6-(2,2,3,3,4,4,4-heptafluorobutoxyl)hexyl 3-mercaptopropanoate C₃F₇CH₂O(CH₂)₆OC(O)CH₂CH₂SH was isolated (11 g, 76% yield).

### Compound 10

Compound 10 illustrates the preparation of 8-(2,2,3,3,4,4,4-heptafluorobutoxyl)octyl 3-mercaptopropanoate from the alcohol in Compound 6. The procedure of Compound 8 was performed, except that 8-(2,2,3,3,4,4,4-heptafluorobutoxyl)octan-1-ol (8.4 g, 25.6 mmol), 3-mercaptopropanoic acid (3.2 g, 30 mmol), and toluenesulfuric acid (0.2 g) were reacted. Pure 8-(2,2,3,3,4,4,4-heptafluorobutoxyl)octyl 3-mercaptopropanoate C₃F₇CH₂O(CH₂)₈OC(O)CH₂CH₂SH was isolated (7.3 g, 69% yield).

### Compound 11

Compound 11 illustrates the preparation of 3-(2,2,3,3-tetrafluoro-3-(2,2,3,3,3-pentafluoropropoxyl)propoxy)propyl 3-mercaptopropanoate from the alcohol in Compound 7. The procedure of Compound 8 was performed, except that 3-(2,2,3,3-tetrafluoro-3-(2,2,3,3,3-pentafluoropropoxyl)propoxy)propan-1-ol (8.6 g, 25.4 mmol), 3-mercaptopropanoic acid (2.8 g, 26.4 mmol), and toluenesulfuric acid (0.1 g) were reacted. Pure 3-(2,2,3,3-tetrafluoro-3-(2,2,3,3,3-pentafluoropropoxyl)propoxy)propyl 3-mercaptopropanoate C₂F₅CH₂OCF₂CF₂CH₂O(CH₂)₃OC(O)CH₂CH₂SH was isolated (7.1 g, 65% yield).

### Example 1

Example 1 illustrates the preparation of aqueous solution of a polymer terminated with the mercaptopropanoate of Compound 8. Acrylamide (8.0 g, 112 mmol), acrylic acid (2.0 g, 28 mmol), and acetonitrile (80 mL, 63 g), and 3-(2,2,3,3,4,4,4-heptafluorobutoxyl)propyl 3-mercaptopropanoate (3.0 g, 8.7 mmol) were charged into a 250-mL flask. The mixture was purged with nitrogen for 2-3 minutes while stirring and then heated to 75° C. under nitrogen. Then deionized water (15 g) was added to the mixture. A solution of VAZO-64 (20 mg, 0.12 mmol) in acetonitrile (10 mL) was slowly charged, while gradually simultaneously charging a solution of acrylamide (2.0 g, 28 mmol) and acrylic acid (0.5 g, 7 mmol) in deionized water (60 mL). The reaction was continued for 5 hours. Acetonitrile was removed by distillation, and the resultant solution was diluted with deionized water to obtain a 17% solids solution and tested according to Test Method 1.

### Example 2

Example 2 illustrates the preparation of aqueous solution of a polymer terminated with the mercaptopropanoate of Compound 9. The procedure of Example 1 was performed, except that 6-(2,2,3,3,4,4,4-heptafluorobutoxyl)hexyl 3-mercaptopropanoate (3.37 g, 8.7 mmol) was used instead of 3-(2,2,3,3,4,4,4-heptafluorobutoxyl)propyl 3-mercaptopropanoate. The resultant solution was diluted with deionized water to obtain a 15.1% solids solution and tested according to Test Method 1.

### Example 3

Example 3 illustrates the preparation of aqueous solution of a polymer terminated with the mercaptopropanoate of Compound 10. The procedure of Example 1 was performed, except that 8-(2,2,3,3,4,4,4-heptafluorobutoxyl)octyl 3-mercaptopropanoate (3.62 g, 8.7 mmol) was used instead of 3-(2,2,3,3,4,4,4-heptafluorobutoxyl)propyl 3-mercaptopropanoate. The resultant solution was diluted with deionized water to obtain a 9.0% solids solution and tested according to Test Method 1.

### Example 4

Example 4 illustrates the preparation of aqueous solution of a polymer terminated with the mercaptopropanoate in Compound 11. The procedure of Example 1 was performed, except that 3-(2,2,3,3-tetrafluoro-3-(2,2,3,3,3-pentafluoropropoxyl)propoxy)propyl 3-mercaptopropanoate (3.7 g, 8.7 mmol) was used instead of 3-(2,2,3,3,4,4,4-heptafluorobutoxyl)propyl 3-mercaptopropanoate. The resultant solution was diluted with deionized water to obtain a 15.7% solids solution and tested according to Test Method 1.

TABLE 5
Surface Tension in Deionized Water at 25° C. (dynes/cm)

| | Weight % of AI | | | | | | | | |
|---|---|---|---|---|---|---|---|---|---|
| Ex. | 0.001 | 0.0025 | 0.005 | 0.01 | 0.025 | 0.05 | 0.1 | 0.25 | 0.5 |
| 1 | 70.4 | 67.5 | 65.4 | 56.6 | 51.8 | 46.0 | 36.2 | 26.9 | 21.8 |
| 2 | 69.2 | 65.6 | 54.9 | 42.0 | 28.1 | 24.3 | 20.8 | 20.5 | 20.4 |
| 3 | 69.0 | 50.4 | 36.7 | 27.3 | 22.2 | 21.2 | 21.0 | 20.7 | 20.5 |
| 4 | 69.6 | 64.6 | 57.9 | 50.1 | 38.3 | 32.0 | 26.2 | 21.9 | 21.6 |

As can be seen from Table 5, the polymers incorporating the partially fluorinated mercaptopropanoates from the present invention provide surface tension reduction to values as low as 20.4 dynes/cm at low concentrations in water. Such a composition would be useful as a surfactant to reduce the surface tension of a variety of formulations.

### Compound 12

Example 12 illustrates the preparation of 3-(2,2,3,3,4,4,4-heptafluorobutoxyl)propyl methacrylate from the alcohol in Compound 4. Cyclohexane (50 mL), 3-(2,2,3,3,4,4,4-heptafluorobutoxyl)propan-1-ol (21 g, 81 mmol), p-toluenesulfonic acid (1.0 g, 5 mmol), and 4-methoxyphenol (0.08 g, 0.6 mmol) were added to a 250-mL flask equipped with a Dean-Stark trap. The resultant mixture was sparged with air for 5 minutes, and then methacrylic acid (9.8 g, 114 mmol) was added. The mixture was refluxed for 12 hours, cooled down, washed with water (2×50 mL), and the organic layer was separated. The organic material was distilled to yield 3-(2,2,3,3,4,4,4-heptafluorobutoxyl)propyl methacrylate C₃F₇CH₂O(CH₂)₃OC(O)C(CH₃)═CH₂ (22.7 g, 85% yield).

### Example 5

Example 5 illustrates the preparation of a copolymer using the methacrylate monomer of Compound 12. Isopropyl alcohol (15 mL), methyl isobutyl ketone (4.5 mL), 2-(diethylamino)ethyl methacrylate (3.0 g, 16 mmol), 3-(2,2,3,3,4,4,4-heptafluorobutoxyl)propyl methacrylate (9.31 g, 28.5 mmol), methacrylic acid (0.5 g, 6 mmol), and acrylic acid (0.5 g, 7 mmol) were added to a 100-mL flask. The resultant mixture was heated to 80° C., a suspension of Vazo 64 (0.25 g, 1.5 mmol) in methyl isobutyl ketone (1 mL) was added, and the mixture was stirred at 80° C. for 8 hours. A mixture of acetic acid (1.95 g, 33 mmol) and water (50 g) at 65° C. was added to the flask, yielding a homogenous dispersion. The isopropyl alcohol and methyl isobutyl ketone solvents were removed by distillation to give an aqueous copolymer dispersion at 18.9% solids. The product was prepared and tested according to Test Methods 2 and 3.

### Compound 13

Compound 13 illustrates the preparation of 3-(2,2,3,3-tetrafluoro-3-(2,2,3,3,3-pentafluoropropoxyl)propoxy)propyl methacrylate from the alcohol in Compound 7. The procedure of Compound 12 was performed, except that 3-(2,2,3,3-tetrafluoro-3-(2,2,3,3,3-pentafluoropropoxyl)propoxy)-propan-1-ol (21.6 g, 64 mmol), p-toluenesulfonic acid (1.0 g, 5 mmol), 4-methoxyphenol (0.08 g, 0.6 mmol), and methacrylic acid (7.7 g, 89 mmol) were reacted. The mixture was refluxed for 14 hours, cooled down, washed with water (2×50 mL), and the organic layer was separated. Pure 3-(2,2,3,3-tetrafluoro-3-(2,2,3,3,3-pentafluoropropoxyl)propoxy)propyl methacrylate C₂F₅CH₂OCF₂CF₂CH₂O(CH₂)₃OC(O)C(CH₃)═CH₂ was isolated (20.5 g, 79% yield).

### Example 6

Example 6 illustrates the preparation of a copolymer using the methacrylate monomer of Compound 13. The procedure of Example 5 was performed, except that 3-(2,2,3,3-tetrafluoro-3-(2,2,3,3,3-pentafluoropropoxyl)propoxy)propyl methacrylate (11.3 g, 27.8 mmol) was used instead of 3-(2,2,3,3,4,4,4-heptafluorobutoxyl)propyl methacrylate. The product was an aqueous copolymer dispersion at 20.0% solids, which was prepared and tested according to Test Methods 2 and 3.

TABLE 6
Water and Oil Beading Test

| | Limestone | | Granite | | Saltillo | | Total | |
|---|---|---|---|---|---|---|---|---|
| Ex. | water | oil | water | oil | water | oil | water | oil |
| Ex. 5 | 3 | 3 | 3 | 2 | 5 | 3 | 11 | 8 |
| Ex. 6 | 3 | 2 | 3 | 2 | 5 | 2 | 11 | 6 |
| Blank | 2 | 1 | 2 | 1 | 0 | 0 | 4 | 2 |

TABLE 7
Stain Resistance Test

| | Limestone | | Granite | | Saltillo | | Total | |
|---|---|---|---|---|---|---|---|---|
| | 1^{st} | 2^{nd} | 1^{st} | 2^{nd} | 1^{st} | 2^{nd} | 1^{st} | 2^{nd} |
| Ex. | stain | stain | stain | stain | stain | stain | stain | stain |
| Ex. 5 | 14 | 15 | 10 | 10 | 21 | 24 | 45 | 49 |
| Ex. 6 | 11 | 11 | 12 | 16 | 21 | 25 | 44 | 52 |
| Blank | 21 | 21 | 21 | 25 | 27 | 26 | 69 | 72 |

As can be seen from Table 7, the polymers incorporating the partially fluorinated (meth)acrylate monomers of the present invention demonstrate superior oil and water repellency on a number of stone or tile surfaces. They also impart superior stain resistance to various hard surfaces.

### Example 7

Example 7 illustrates the preparation of polymeric urethane based on the alcohol in Compound 4. Methyl isobutyl ketone (5 g), Desmodur N 3300 (7.4 g), iron trichloride (1.3 mg), and MPEG-750 (5.7 g) were charged into a 100-mL flask and stirred at 60° C. for 30 minutes. Then 3-(2,2,3,3,4,4,4-heptafluorobutoxyl)propan-1-ol (5.5 g, 21 mmol) was added, and the mixture was stirred at 95° C. for 4 hours. Methyl isobutyl ketone (7.5 g) and water (0.6 g) were added, and stirring was continued at 85° C. for 4 hours. After that, hot water (64 g) was added to the mixture, and stirring was continued at 85° C. for 1 hour. Methyl isobutyl ketone was removed by vacuum distillation, and the reaction mass was diluted with water to yield a solution at 20% solids content. The solution was prepared and tested according to Test Method 4 as described above.

### Example 8

Example 8 illustrates the preparation of a polymeric urethane based on the alcohol in Compound 5. The process of Example 7 was performed, except that 6-(2,2,3,3,4,4,4-heptafluorobutoxyl)hexan-1-ol (6.4 g, 21 mmol) was used instead of 3-(2,2,3,3,4,4,4-heptafluorobutoxyl)propan-1-ol. A solution with 20% solids content was prepared and tested according to Test Method 4 as described above.

### Example 9

Example 9 illustrates the preparation of polymeric urethane based on alcohol in Compound 7. The process of Example 7 was performed, except that 3-(2,2,3,3-tetrafluoro-3-(2,2,3,3,3-pentafluoropropoxyl)propoxy)-propan-1-ol (7.2 g, 21 mmol) was used instead of 3-(2,2,3,3,4,4,4-heptafluorobutoxyl)propan-1-ol. A solution with 20% solid content was prepared and tested according to Test Method 4 as described above.

TABLE 8
Leveling performance.

| Example | Leveling Rating |
|---|---|
| Example 7 | 1.7 |
| Example 8 | 2.0 |
| Example 9 | 2.4 |
| Blank | 1.0 |

The examples show that urethane polymers incorporating the partially fluorinated alcohols of the present invention demonstrate superior leveling performance in industrial coatings.

What is claimed is:

1. A polymer comprising the reaction product of:
(a) a compound of Formula (3), or a mixture thereof: 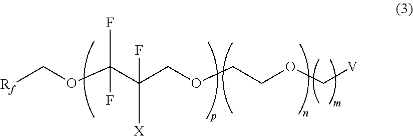
wherein
R_{f} is C₁ to C₆ linear or branched fluoroalkyl,
X is F or Cl,
V is —YC(O)CR²═CH₂, —YC(O)R¹⁹SH, or —YC(O)NHCH₂CH₂OC(O)CR²═CH₂,
Y is O or a single bond,
R² is independently selected from H or a C₁ to C₄ alkyl group,
R¹⁹ is an alkylene of about 1 to about 10 carbon atoms,
p is 0 to 1,
m is 0 or 3 to 10, and
n is 0 to 30,
wherein at least one of p or m is a positive integer;
provided that, if n is a positive integer, then p is 1; and
provided that, if m is 0 then Y is a single bond, and if m is a positive integer then
Y is O; and
(b) at least one ethylenically unsaturated monomer having a functional group selected from a linear or branched hydrocarbon, alcohol, anhydride, ether, ester, formate, carboxylic acid, carbamate, urea, amine, amide, sulfonate, sulfonic acid, sulfonamide, halide, saturated or unsaturated cyclic hydrocarbon, morpholine, pyrrolidine, piperidine, or mixtures thereof.

2. The polymer of claim 1, wherein compound (a) of Formula (3) is reacted with
(b) a monomer selected from Formula (4) or Formula (5), or a mixture thereof:
CH₂═C(R³)COZ(CH₂)_{q}(CHR³)ᵢNR⁴R⁵ Formula (4)
CH₂═C(R³)NR⁶R⁷ Formula (5)
wherein
R³ is independently selected from H or CH₃,
R⁴ and R⁵ are each independently C₁ to C₄ alkyl, hydroxyethyl, or benzyl; or R⁴ and R⁵ together with the nitrogen atom form a morpholine, pyrrolidine, or piperidine ring,
R⁶ and R⁷ are each independently selected from H or C₁ to C₄ alkyl,
Z is —O— or —NR⁸—
wherein
R⁸ is H or C₁-C₄ alkyl,
i is 0 to 4, and
q is 1 to 4,
provided that the nitrogen bonded to R⁴ and R⁵ is from about 0% to 100% salinized, quaternized, or present as amine oxide; and
(c) a monomer of Formula (6), or a mixture thereof:
CH₂═CR⁹(R¹⁰)ₑ—COOH Formula (6)
wherein
R⁹ is independently selected from H or CH₃,
R¹⁰ is CO(CH₂)₅, CO(O)(CH₂)₂, C₆H₄CHR⁹, or C(O)NR⁹R¹¹,
R¹¹ is C₆H₄OCH₂, (CH₂)_{d}, or C(CH₃)₂CH₂,
d is 1 to about 10, and
e is 0 or 1.

3. The polymer of claim 2, wherein V is —YC(O)CR²═CH₂ or —YC(O)NHCH₂CH₂OC(O)CR²═CH₂.

4. The polymer of claim 3, wherein the compounds are reacted in the following percentages by weight: from about 30% to about 90% of a compound of Formula (3), from about 9% to about 40% of a monomer of Formula (4), and from about 1% to about 30% of a monomer of Formula (6), wherein the sum of the monomer components equals 100%.

5. The polymer of claim 2, wherein V is —YC(O)R¹⁹SH.

6. The polymer of claim 5, wherein the compounds are reacted in the following percentages by weight: from about 4% to about 40% of a compound of Formula (3), from about 30% to about 95% of a monomer of Formula (5), and from about 1% to about 30% of a monomer of Formula (6), wherein the sum of the monomer components equals 100%.

7. The polymer of claim 2 where at least one additional monomer is copolymerized, selected from the group consisting of ethylenically unsaturated monomers having a functional group selected from a linear or branched hydrocarbon, alcohol, anhydride, ether, ester, formate, carboxylic acid, carbamate, urea, amine, amide, sulfonate, sulfonic acid, sulfonamide, halide, saturated or unsaturated cyclic hydrocarbon, morpholine, pyrrolidine, piperidine, or mixtures thereof.

8. A polymer having at least one carbamate linkage prepared by:
(i) reacting (a) at least one diisocyanate, polyisocyanate, or mixture thereof, having isocyanate groups, and (b) at least one fluorinated compound selected from the formula (2): 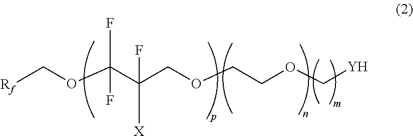
wherein
R_{f} is C₁ to C₆ linear or branched fluoroalkyl,
X is F or Cl,
Y is O or a single bond,
p is 0 to 1,
m is 0 or 3 to 10, and
n is 0 to 30,
wherein at least one of p or m is a positive integer;
provided that, if n is a positive integer, then p is 1; and
provided that, if m is 0 then Y is a single bond, and if m is a positive integer then
Y is O; and
(ii) optionally reacting with (c) water, a linking agent, or a mixture thereof.

9. The polymer of claim 8 wherein said fluorinated compound reacts with about 5 mol % to about 90 mol % of said isocyanate groups.

10. The polymer of claim 8 wherein the diioscyanate or polyisocyanate is selected from the group consisting of hexamethylene diisocyanate homopolymer, 3-isocyanatomethyl-3,4,4-trimethylcyclohexyl isocyanate, bis-(4-isocyanatocylohexyl)methane and diisocyanate trimers of formulas (12a), (12b), (12c) and (12d):

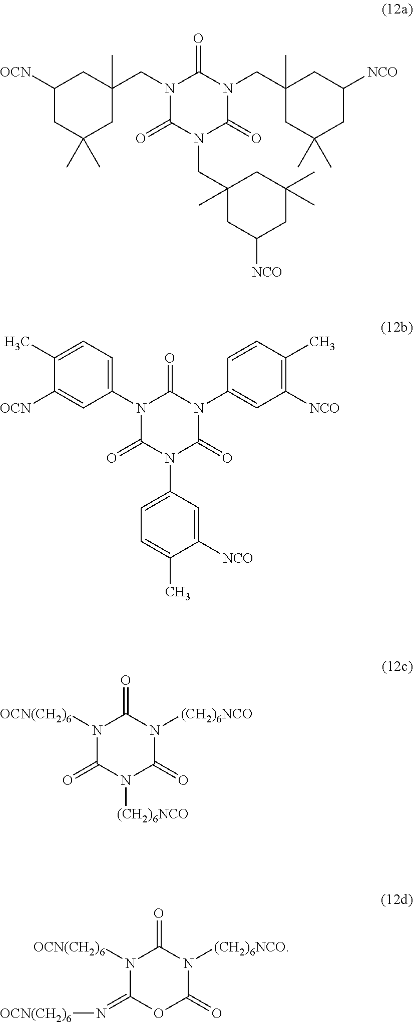

11. The polymer of claim 8 wherein step (i) further comprises reacting (d) a non-fluorinated organic compound selected from the group consisting of Formula (13)
R¹²—(R¹³)ₖ-QH (13)
wherein
R¹² is a C₁-C₁₈ alkyl, a C₁-C₁₈ omega-alkenyl radical or a C₁-C₁₈ omega-alkenyl;
k is 0 or 1;
Q is —O—, —S—, or —NR¹⁷— in which R¹⁷ is H or alkyl containing 1 to 6 carbon atoms; and
R¹³ is selected from the group consisting of 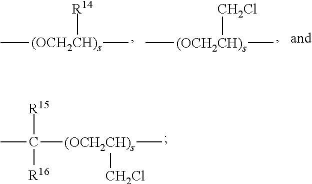
wherein
R¹⁴, R¹⁵ and R¹⁶ are each independently H or C₁ to C₆ alkyl, and
s is an integer of 1 to 50.

12. The polymer of claim 11, wherein the compound of Formula (13) comprises a hydrophilic water-solvatable material comprising at least one hydroxy-terminated polyether of Formula (14):
R¹⁸—O(CH₂CH₂O)ⱼ—(CH₂CH(CH₃)O)ⱼ₁—CH₂CH₂O)ⱼ₂—H Formula (14)
wherein
R¹⁸ is a monovalent hydrocarbon radical containing from about one to about six aliphatic or alicyclic carbon atoms;
j is a positive integer, and j1 and j2 are each independently a positive integer or zero;
said polyether having a weight average molecular weight up to about 2000.

13. The polymer of claim 11 wherein said non-fluorinated compound reacts with about 0.1 mol % to about 60 mol % of said isocyanate groups.

14. The polymer of claim 8 wherein the carbamate linkage is formed using a diamine or polyamine.

15. The polymer of claim 8 in the form of an aqueous dispersion or solution.

16. The polymer of claim 8 wherein R_{f} is C₁ to C₃ linear fluoroalkyl.

17. A method of providing water repellency, oil repellency, and stain resistance to a substrate comprising contacting the substrate with a polymer of claim 1, 2, or 8.

18. A substrate having water repellency, oil repellency, and stain resistance, comprising a polymer of claim 1, 2, or 8.
